(19) United States
(12) Patent Application Publication
(10) Pub. No.: US 2024/0319666 A1
(43) Pub. Date: Sep. 26, 2024

(54) IMAGE FORMING APPARATUS

(71) Applicant: FUJIFILM Business Innovation Corp., Tokyo (JP)

(72) Inventors: Yuta SHIMATATE, Kanagawa (JP); Shunsuke YAMASAKI, Kanagawa (JP)

(73) Assignee: FUJIFILM Business Innovation Corp., Tokyo (JP)

(21) Appl. No.: 18/357,233

(22) Filed: Jul. 24, 2023

(30) Foreign Application Priority Data
Mar. 20, 2023 (JP) 2023-043693

(51) Int. Cl. G03G 21/20

(52) U.S. Cl. CPC G03G 21/206

(57) ABSTRACT

An image forming apparatus includes a housing, a developing device disposed in the housing and including a container that contains a developer, a transport member that rotates to transport the developer in the container, and bearing units that bear a shaft of the transport member, a ventilator disposed in the housing to pass by at least a rear end of the developing device in a longitudinal direction of the developing device and having a channel space through which air outside the housing flows in and is then discharged out of the housing, and a thermal conductor that is provided to the ventilator and transfers heat of the bearing unit at least at the rear end of the developing device to at least the ventilator by being in contact with a part of the bearing unit.

### CROSS-REFERENCE TO RELATED APPLICATIONS

This application is based on and claims priority under 35 USC 119 from Japanese Patent Application No. 2023-043693 filed Mar. 20, 2023.

### BACKGROUND

### (i) Technical Field

The present disclosure relates to an image forming apparatus.

### (ii) Related Art

Japanese Patent No. 6041524 (claim 1, paragraphs 0034 to 0036, FIGS. 1 to 3) describes an image forming apparatus in which a heat dissipation member and a duct that covers the heat dissipation member and forms an airflow by taking air into the duct by a fan are provided outside a side surface of a developing device along its longitudinal direction and an opening is provided at the top of the duct in the longitudinal direction to send a part of the air.

### SUMMARY

Aspects of non-limiting embodiments of the present disclosure relate to an image forming apparatus using a developing device. Even if components such as heat dissipation fins and a ventilator having a channel space through which air flows are difficult to add along a longitudinal direction of a developing device, an increase in the temperature of a developer in the developing device is suppressed compared with a case where heat is not reduced from a bearing unit of a transport member at least at the rear end of the developing device in the longitudinal direction.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus comprising: a housing; a developing device disposed in the housing and comprising a container that contains a developer, a transport member that rotates to transport the developer in the container, and bearing units that bear a shaft of the transport member; a ventilator disposed in the housing to pass by at least a rear end of the developing device in a longitudinal direction of the developing device and having a channel space through which air outside the housing flows in and is then discharged out of the housing; and a thermal conductor that is provided to the ventilator and transfers heat of the bearing unit at least at the rear end of the developing device to at least the ventilator by being in contact with a part of the bearing unit.

### BRIEF DESCRIPTION OF THE DRAWINGS

An exemplary embodiment of the present disclosure will be described in detail based on the following figures, wherein:

FIG. 1 illustrates the inside of an image forming apparatus according to an exemplary embodiment;

FIG. 2 is a schematic sectional view of the inside of a developing device in the image forming apparatus of FIG. 1;

FIG. 3 is a top view of the developing device of FIG. 2;

FIG. 4 is a top view of a part of the image forming apparatus of FIG. 1;

FIG. 5A is a schematic perspective view of the developing device and a ventilator in the image forming apparatus of FIG. 1;

FIG. 5B is a schematic perspective view of a state in which thermal conductors are added in FIG. 5A;

FIG. 6 is a partially enlarged view of FIG. 4;

FIG. 7A illustrates a bearing unit of the developing device of FIG. 2 and its periphery;

FIG. 7B illustrates a state in which the thermal conductor is added in FIG. 7A;

FIG. 8A illustrates the rear end of the developing device of FIG. 2 and the thermal conductor;

FIG. 8B illustrates the developing device of FIG. 8A that is tilted for mounting or demounting;

FIG. 9A is a schematic perspective view of the thermal conductor; and

FIG. 9B is a top view of the thermal conductor of FIG. 9A.

### DETAILED DESCRIPTION

An exemplary embodiment of the present disclosure is described.

### Exemplary Embodiment

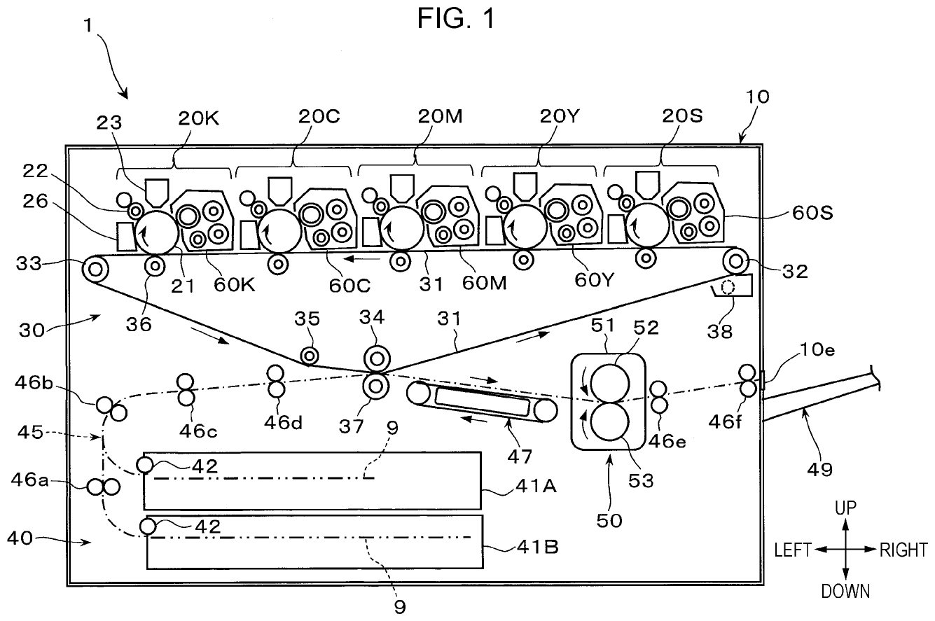

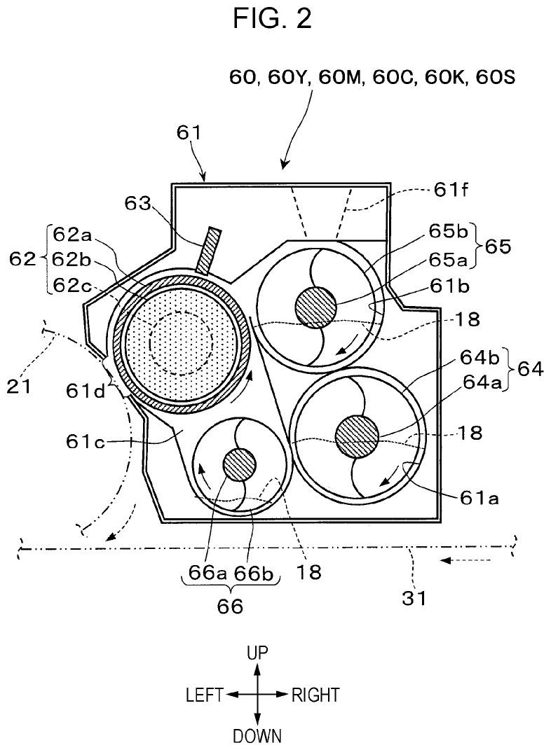

FIG. 1 illustrates an image forming apparatus according to the exemplary embodiment of the present disclosure. FIG. 2 illustrates the inside of a developing device in the image forming apparatus of FIG. 1.

In the description herein and the illustration in the drawings, substantially the same components are represented by the same reference symbols, and redundant description of those components is omitted herein.

### (1-1) Structure of Image Forming Apparatus

As illustrated in FIG. 1, an image forming apparatus 1 forms an image developed with a dry developer on recording paper 9 that is an example of a recording medium. The image forming apparatus 1 may form an image based on image information input from a connected external device such as an information terminal. Examples of the developer include a two-component developer containing a toner and a carrier.

As illustrated in FIG. 1, the image forming apparatus 1 includes image forming units 20, an intermediate transfer unit 30, a medium feeder 40, a fixing unit 50, and a controller (not illustrated) in an internal space of a housing 10. In FIG. 1, each chain line represents a transport path 45 of the recording paper 9 in the housing 10.

The housing 10 is a box structure manufactured into a desired appearance by using materials such as structural materials typified by frames and covering materials typified by panels and doors. In the exemplary embodiment, the housing 10 has a substantially rectangular parallelepiped appearance, but may have an appearance other than the rectangular parallelepiped appearance.

The image forming units 20 are a group of devices that form toner images with toners serving as developers based on image information.

In the exemplary embodiment, the image forming units 20 include, for example, image forming units 20Y, 20M, 20C, 20K, and 20S (may hereinafter be referred to simply as 20(Y, M, C, K, S)) that independently form toner images in yellow (Y), magenta (M), cyan (C), black (K), and a special color (S). Examples of the special color (S) include white and a transparent color.

The image forming units 20Y, 20M, 20C, 20K, and 20S have substantially the same structure except that developing devices 60 use developers (toners in this example) in different colors Y, M, C, K, and S, respectively.

That is, each image forming unit 20(Y, M, C, K, S) includes a photoconductor drum 21 that is an example of a latent image carrier that holds a latent image formed thereon. Each image forming unit 20(Y, M, C, K, S) includes devices such as a charging device 22, an exposing device 23, the developing device 60(Y, M, C, K, S), a first transfer device 36, and a drum cleaning device 26 around the photoconductor drum 21.

The image forming units 20(Y, M, C, K, S) are arranged in a row with desired lateral distances in the internal space of the housing 10 when viewed from the front of the image forming apparatus 1. The front is a side that a person faces when standing in front of the image forming apparatus 1.

In FIG. 1, the photoconductor drum, the charging device, the exposing device, the developing device, the first transfer device, and the drum cleaning device of the image forming unit 20K are represented by reference symbols “21”, “22”, “23”, “60K”, “36”, and “26”, respectively. In the other image forming units 20(Y, M, C, S) of FIG. 1, reference symbols “60Y”, “60M”, “60C”, and “60S” of the developing devices are used and reference symbols of the other devices are omitted.

The photoconductor drum 21 is a drum-shaped photoconductor that rotates in an arrow direction about a rotation axis (not illustrated) extending along a fore-and-aft direction.

The charging device 22 charges the outer peripheral surface of the photoconductor drum 21 serving as an image forming surface at a desired surface potential. The charging device 22 includes a charging member such as a charging roller that is in contact with an image forming area of the outer peripheral surface of the photoconductor drum 21 and is supplied with a charging current.

The exposing device 23 exposes the charged outer peripheral surface of the photoconductor drum 21 to light based on the image information to form an electrostatic latent image.

The developing device 60 develops the electrostatic latent image on the outer peripheral surface of the photoconductor drum 21 with a developer of a predetermined corresponding color (Y, M, C, K, or S) into a toner image that is an example of a visible image. Details of the developing device 60 are described later.

The first transfer device 36 transfers the toner image on the outer peripheral surface of the photoconductor drum 21 of each image forming unit 20(Y, M, C, K, S) onto an intermediate transfer belt 31 of the intermediate transfer unit 30. The first transfer device 36 includes a transfer member such as a transfer roller that is in contact with the outer peripheral surface of the photoconductor drum 21 and is supplied with a first transfer current. The first transfer device 36 may be handled as a component of the intermediate transfer unit 30.

The drum cleaning device 26 cleans the outer peripheral surface of the photoconductor drum 21 by removing unwanted matter such as unnecessary toner and paper dust adhering to the outer peripheral surface of the photoconductor drum 21.

The intermediate transfer unit 30 is a group of devices that transfer the toner images formed by the image forming units 20(Y, M, C, K, S) onto the recording paper 9 after temporarily holding the toner images on an intermediate transfer body.

The intermediate transfer unit 30 includes the intermediate transfer belt 31 that is an example of the intermediate transfer body, support rollers 32 to 35 that rotatably support the inner peripheral surface of the intermediate transfer belt 31, the first transfer devices 36, a second transfer device 37, and a belt cleaning device 38. The intermediate transfer unit 30 is disposed below the image forming units 20(Y, M, C, K, S) in the internal space of the housing 10.

The intermediate transfer belt 31 is an annular belt having a desired width and a desired length, and its outer peripheral surface may electrostatically hold the toner images.

The support rollers 32 to 35 support the intermediate transfer belt 31 in a substantially inverted triangle shape so that the intermediate transfer belt 31 is rotatable in an arrow direction.

The support rollers 32 and 33 support the intermediate transfer belt 31 to form a transfer surface laterally extending over a plane along an array of the photoconductor drums 21 of the image forming units 20(Y, M, C, K, S). For example, the support roller 32 is a driving roller that applies power for rotating the intermediate transfer belt 31.

The support roller 34 is a second transfer back roller that faces the second transfer device 37 and supports the inner peripheral surface of the intermediate transfer belt 31. The support roller 35 is a tensile force application roller that applies a desired tensile force to the intermediate transfer belt 31.

The first transfer devices 36 push the intermediate transfer belt 31 against the first transfer portions of the photoconductor drums 21 of the image forming units 20(Y, M, C, K, S).

The second transfer device 37 transfers, onto the recording paper 9, the toner images firstly transferred onto the outer peripheral surface of the intermediate transfer belt 31. The second transfer device 37 includes a transfer member such as a transfer roller or a transfer transport belt that is in contact with the outer peripheral surface of the intermediate transfer belt 31 supported by the support roller 35 and is supplied with a second transfer current.

The belt cleaning device 38 cleans the outer peripheral surface of the intermediate transfer belt 31 by removing unwanted matter such as unnecessary toner and paper dust adhering to the outer peripheral surface of the intermediate transfer belt 31.

The medium feeder 40 contains and feeds sheets of recording paper 9 to the second transfer position of the intermediate transfer unit 30. For example, the medium feeder 40 is disposed below the intermediate transfer unit 30 in the internal space of the housing 10.

The medium feeder 40 includes containers 41A and 41B that contain the sheets of recording paper 9, and sending devices 42 that send out the sheets of recording paper 9 one by one from the containers 41A and 41B. The recording paper 9 is a medium cut into a predetermined size. The number of containers 41 is not particularly limited.

The fixing unit 50 fixes, onto the recording paper 9, the unfixed toner images secondly transferred onto the recording paper 9 by the intermediate transfer unit 30. For example, the fixing unit 50 is disposed below one side of the intermediate transfer unit 30 in the internal space of the housing 10.

The fixing unit 50 includes devices such as a heating rotator 52 and a pressurizing rotator 53 in an internal space of a cover 51 having an inlet and an outlet for the recording paper 9. The heating rotator 52 and the pressurizing rotator 53 are rollers or belts. In the fixing unit 50, a contact portion between the heating rotator 52 and the pressurizing rotator 53 (so-called nip) serves as a fixing portion where heating and pressurization are performed to fix the unfixed toner images onto the recording paper 9.

The transport path 45 includes a path from the containers 41A and 41B of the medium feeder 40 to the fixing unit 50 via the second transfer portion of the intermediate transfer unit 30, and a path from the fixing unit 50 to a medium outlet 10e of the housing 10.

For example, the transport path 45 is formed by a plurality of transport roller pairs 46a, 46b, 46c, 46d, 46e, and 46f, an attractive belt transport device 47, and a transport guide (not illustrated). The attractive belt transport device 47 is disposed in a path connecting the second transfer portion of the intermediate transfer unit 30 and the fixing unit 50.

A paper output portion 49 that receives the recording paper 9 output through the medium outlet 10e is provided outside the housing 10. The paper output portion 49 is not limited to a receiving tray and may be a component of a post-processing apparatus.

### (1-2) Operation of Image Forming Apparatus

The image forming apparatus 1 performs a sequential basic image forming operation when the controller (not illustrated) receives a command for the image forming operation from an external device or the like.

In the image forming apparatus 1, any one image forming unit 20(Y, M, C, K, S) performs charging, exposing, developing, and cleaning operations, and the intermediate transfer unit 30 performs a first transfer operation and a second transfer operation. In the image forming apparatus 1, an operation of supplying the recording paper 9 is performed by the medium feeder 40 and the transport path 45.

Thus, a toner image is formed on the photoconductor drum 21 of the any one image forming unit 20(Y, M, C, K, S), and then firstly transferred onto the intermediate transfer belt 31 of the intermediate transfer unit 30 and secondly transferred onto the recording paper 9.

In the image forming apparatus 1, the recording paper 9 onto which the toner image has been secondly transferred by the intermediate transfer unit 30 is transported into the fixing unit 50 by a transport operation of the transport path 45, and a fixing operation is performed by the fixing unit 50.

Thus, the unfixed toner image is fixed onto the recording paper 9.

The recording paper 9 after the fixing is transported by the transport operation of the transport path 45 and then output to the paper output portion 49 outside the housing 10.

In the manner described above, the image forming apparatus 1 completes the basic image forming operation for forming the toner image on one side of one sheet of recording paper 9.

For example, when all the image forming units 20(Y, M, C, K) perform the image forming operation, a full color image is formed by toner images in four colors (Y, M, C, K). In the image forming apparatus 1, the image forming unit 20S may perform the image forming operation as necessary to form a toner image in the special color (S).

### (1-3) Structure of Developing Device

The developing devices 60(Y, M, C, K, S) are described in detail.

The developing devices 60(Y, M, C, K, S) have substantially the same structure except that the colors of developers 18 are different.

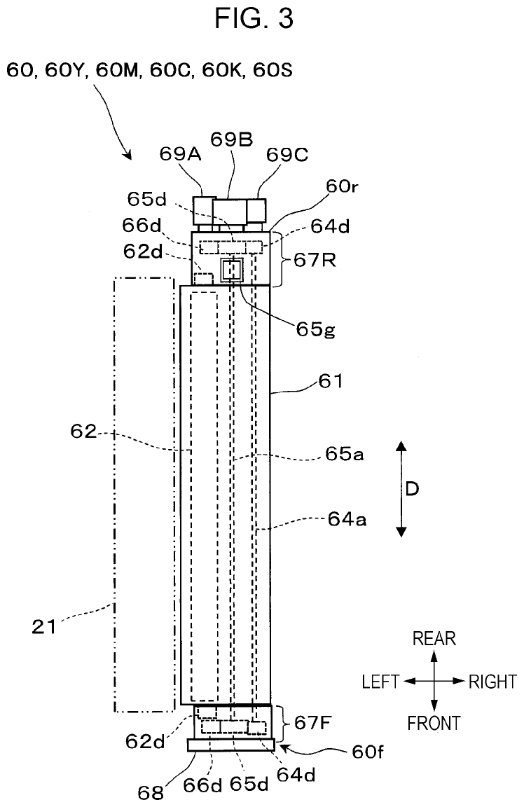

As illustrated in FIGS. 2, 3, and the like, the developing device 60(Y, M, C, K, S) includes an elongated container-shaped housing 61 extending in a direction substantially parallel to the rotation axis of the photoconductor drum 21 (hereinafter referred to as “longitudinal direction D”: see FIG. 3).

The housing 61 has a plurality of containing portions 61a, 61b, and 61c separately defined to contain and transport the developer 18, and an opening 61d for the developing step. The housing 61 has bearing units 67 at both ends in the longitudinal direction D, a side plate 68, and the like.

The developer 18 is a dry developer such as a two-component developer containing a non-magnetic toner and a magnetic carrier.

The containing portion 61a serves as an agitating transport path portion. The containing portion 61b serves as a supply transport path portion. The containing portion 61c serves as a developing and collection transport path portion.

The agitating transport path portion 61a transports the developer 18 in one direction of the longitudinal direction D while agitating the developer 18, and sends the developer 18 into the supply transport path portion 61b. The supply transport path portion 61b transports the developer 18 in one direction of the longitudinal direction D while agitating the developer 18, and supplies the developer 18 to the developing and collection transport path portion 61c during the transport.

The agitating transport path portion 61a and the supply transport path portion 61b are structural portions having tubular or grooved spaces extending along the longitudinal direction D, and are connected via communication passages at both ends in the longitudinal direction D.

In the developing and collection transport path portion 61c, a developing roller 62 performs the developing step, and the developer 18 released from the developing roller 62 after the developing step is collected and returned to the agitating transport path portion 61a.

The developing and collection transport path portion 61c is a structural portion having a tubular space extending along the longitudinal direction D and an oblique up-and-down direction. The developing and collection transport path portion 61c is connected to the agitating transport path portion 61a via a communication passage at one end in the longitudinal direction D. The developing and collection transport path portion 61c is connected to the supply transport path portion 61b via a supply opening extending along the longitudinal direction D.

The opening 61d is a rectangular opening facing the photoconductor drum 21 and extending along the rotation axis of the photoconductor drum 21. The opening 61d is connected to an upper part of the developing and collection transport path portion 61c along the longitudinal direction D.

The bearing units 67 include bearings 62d, 64d, 65d, and 66d for shafts of the developing roller 62, an agitating transport member 64, a supply transport member 65, and a collection transport member 66 described later.

The bearing units 67 include a front bearing unit 67F provided at a front end 60f of the developing device 60 (or the housing 61) in the longitudinal direction D, and a rear bearing unit 67R provided at a rear end 60r in the longitudinal direction D.

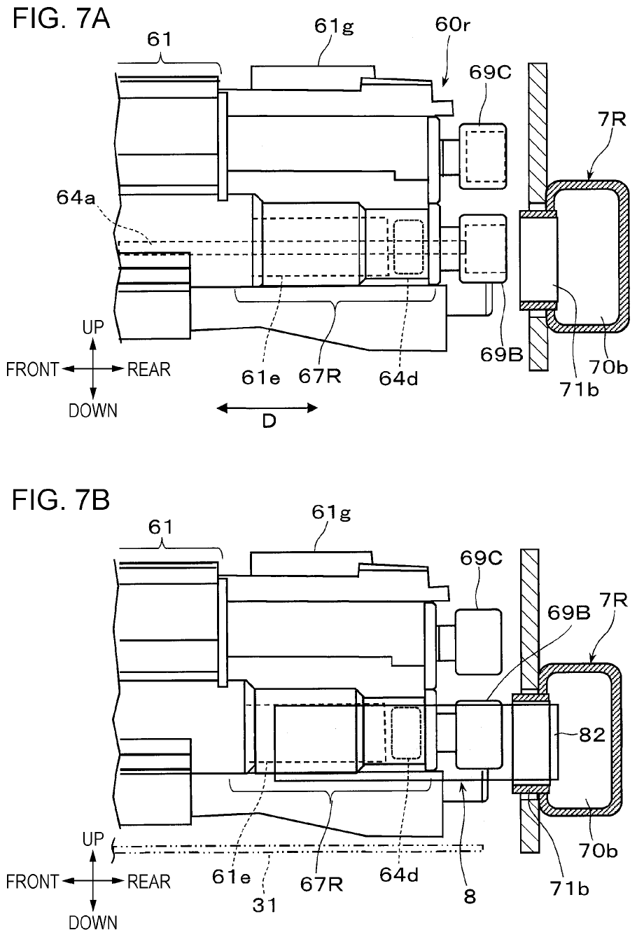

The entire bearing unit 67 is enclosed by, for example, a cover having a desired shape. As illustrated in FIGS. 7A and 7B, the rear bearing unit 67R includes an extension portion 61e of the agitating transport path portion 61a in addition to the bearings 62d, 64d, 65d, and 66d. The rear bearing unit 67R has a reception port 61g at its upper part to receive the replenishment developer 18 from a developer replenishment device (not illustrated).

The bearings 62d, 64d, 65d, and 66d are rolling bearings such as ball bearings, but may be plain bearings.

The side plate 68 is provided at the front end 60f of the developing device 60. The side plate 68 has a handle, a positioner, and the like.

In the developing device 60(Y, M, C, K, S) illustrated in FIG. 2, the developing roller 62 that is an example of a transport member is rotatably disposed at the upper part of the developing and collection transport path portion 61c, and a plate-shaped developer regulating member 63 is fixed to regulate the amount (layer thickness) of the developer held by the developing roller 62.

In the developing device 60(Y, M, C, K, S), the agitating transport member 64 that is an example of the transport member is rotatably disposed in the agitating transport path portion 61a, the supply transport member 65 that is an example of the transport member is rotatably disposed in the supply transport path portion 61b, and the collection transport member 66 that is an example of the transport member is rotatably disposed at a lower part of the developing and collection transport path portion 61c.

The developing roller 62 includes a cylindrical developing sleeve 62a that rotates while holding the developer 18, and a magnet roller 62b fixed in an internal space of the developing sleeve 62a.

The developing sleeve 62a is disposed to face, with a predetermined distance, a part of the photoconductor drum 21 where an electrostatic latent image is formed. The developing sleeve 62a is made of a non-magnetic material into a cylindrical shape.

The developing sleeve 62a has shafts 62c at both ends. The shafts 62c of the developing sleeve 62a are rotatably attached to the bearings 62d of the bearing units 67F and 67R. The developing sleeve 62a is driven to rotate in an arrow direction with rotational power transmitted from a rotational drive device (not illustrated) to the shaft 62c via a coupler (e.g., a coupling) 69A.

A developing bias current is supplied between the developing sleeve 62a and the photoconductor drum 21 from a power supply device (not illustrated).

The magnet roller 62b has a plurality of magnetic poles that generates magnetic forces for exerting functions of attracting the developer 18 toward the outer peripheral surface of the developing sleeve 62a, transporting and holding the developer 18, and releasing the developer 18 from the outer peripheral surface.

The agitating transport member 64, the supply transport member 65, and the collection transport member 66 are so-called screw augers including rotation shafts 64a, 65a, and 66a and transport blades 64b, 65b, and 66b helically wound around the rotation shafts 64a, 65a, and 66a at desired pitches.

As illustrated in FIG. 3, the rotation shafts 64a and 65a of the agitating transport member 64 and the supply transport member 65 are rotatably attached to the bearings 64d and 65d of the bearing units 67F and 67R, respectively. The rotation shafts 64a and 65a of the agitating transport member 64 and the supply transport member 65 are driven to rotate in arrow directions with rotational power transmitted from rotational drive devices (not illustrated) via couplers (e.g., couplings) 69B and 69C, respectively.

Each developing device 60(Y, M, C, K, S) is mountable on or demountable from a mount of the housing 10 by a first operation for moving the developing device 60(Y, M, C, K, S) in the fore-and-aft direction of the housing 10.

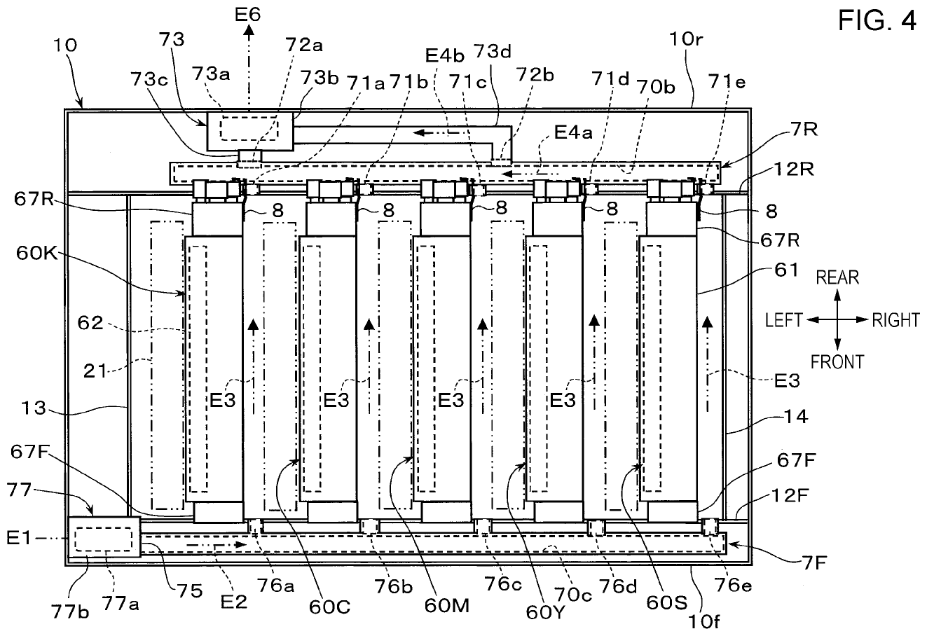

As illustrated in FIG. 4, the developing device 60(Y, M, C, K, S) is mounted in a mounting space between a front support frame 12F laterally extending in a front interior of the housing 10 and a rear support frame 12R laterally extending in a rear interior of the housing 10.

When mounting each developing device 60(Y, M, C, K, S), the couplers 69A, 69B, and 69C are separably coupled to couplers of the rotational drive devices (not illustrated) disposed in a space between the rear support frame 12R and a back portion 10r of the housing 10 (see FIG. 4).

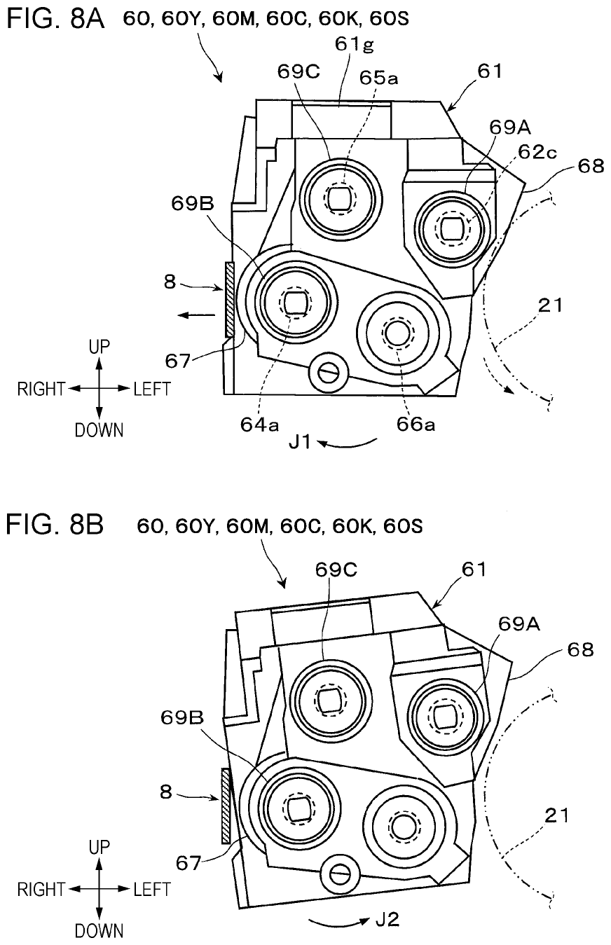

As illustrated in FIGS. 8A and 8B, each developing device 60(Y, M, C, K, S) is turned in directions indicated by arrows J1 and J2 about the rotation shaft 65a of the supply transport member 65 as a second operation for mounting and demounting.

When performing the first operation to remove the developing device 60(Y, M, C, K, S), the second operation is performed to turn the developing device 60(Y, M, C, K, S) in the direction indicated by the arrow J2 about the rotation shaft 65a. Thus, the developing device 60(Y, M, C, K, S) is temporarily held in a non-contact state in which the housing 61 or the like is not in contact with the photoconductor drum 21 as illustrated in FIG. 8B.

To complete the mounting of the developing device 60(Y, M, C, K, S), the second operation is performed to turn the developing device 60(Y, M, C, K, S) in the direction indicated by the arrow J1 about the rotation shaft 65a as illustrated in FIG. 8A. Thus, the housing 61 and the like of the developing device 60(Y, M, C, K, S) are close to the photoconductor drum 21 as illustrated in FIG. 2, and the developing roller 62 is positioned with a predetermined distance from the photoconductor drum 21 (mounted position).

### (1-4) Operation of Developing Device

The developing device 60(Y, M, C, K, S) performs a developing operation at an appropriate timing.

In the developing device 60(Y, M, C, K, S), the developing sleeve 62a of the developing roller 62, the agitating transport member 64, the supply transport member 65, and the collection transport member 66 start to rotate in desired directions, and a developing bias voltage starts to be supplied to the developing sleeve 62a at a desired timing.

In the developing device 60(Y, M, C, K, S), the developer 18 is transported while being agitated by the agitating transport member 64 that rotates in the agitating transport path portion 61a, and is gradually sent into the supply transport path portion 61b. Subsequently, the developer 18 is sent into the developing and collection transport path portion 61c by the supply transport member 65 that rotates in the supply transport path portion 61b.

In the developing and collection transport path portion 61c, the developer 18 sent from the supply transport path portion 61b is supplied to and partially held by the rotating developing roller 62. The developer 18 in the supply transport path portion 61b that is not held by the developing roller 62 is returned to the agitating transport path portion 61a by the transport force of the supply transport member 65.

In the developing device 60(Y, M, C, K, S), the developer 18 supplied to the developing roller 62 is transported by the rotating developing sleeve 62a and regulated into a desired amount (layer thickness) when passing by the developer regulating member 63. Then, the developer 18 is supplied to the rotating photoconductor drum 21 by a developing field.

As a result, the toner of a part of the developer 18 supplied to the developing roller 62 is used for the developing step by adhering to the electrostatic latent image.

In the developing device 60(Y, M, C, K, S), the toner of the developer 18 on the developing sleeve 62a that is not used for the developing step is released from the developing sleeve 62a and falls into the lower part of the developing and collection transport path portion 61c. The fallen developer 18 is collected by the collection transport member 66 that rotates in the lower part of the developing and collection transport path portion 61c, and is returned to the agitating transport path portion 61a.

### (1-5) Structures of Ventilators and Other Components

As illustrated in FIG. 4 and the like, the image forming apparatus 1 includes ventilation ducts that are examples of ventilators 7 having channel spaces 70 through which air outside the housing 10 flows in and then flows out of the housing 10.

In the exemplary embodiment, the ventilators 7 include a front ventilation duct 7F and a rear ventilation duct 7R.

The front ventilation duct 7F is an example of a front ventilator disposed in the housing 10 to pass by the front ends 60f of the developing devices 60(Y, M, C, K, S) in the longitudinal direction D.

The front ventilation duct 7F is a tubular structure having a channel space 70c through which air flows. As illustrated in FIG. 4 and the like, the front ventilation duct 7F laterally extends in a space between a front portion 10f of the housing 10 and the front support frame 12F. The front ventilation duct 7F is made of a synthetic resin, but at least a part of the front ventilation duct 7F may be made of a metal.

As illustrated in FIG. 4, the front ventilation duct 7F has an air inlet 75, air outlets 76a, 76b, 76c, 76d, and 76e, and an intake fan 77.

The air inlet 75 is an opening through which air E1 outside the housing 10 flows into the channel space 70c. For example, the air inlet 75 is provided at one end of the front ventilation duct 7F in its longitudinal direction.

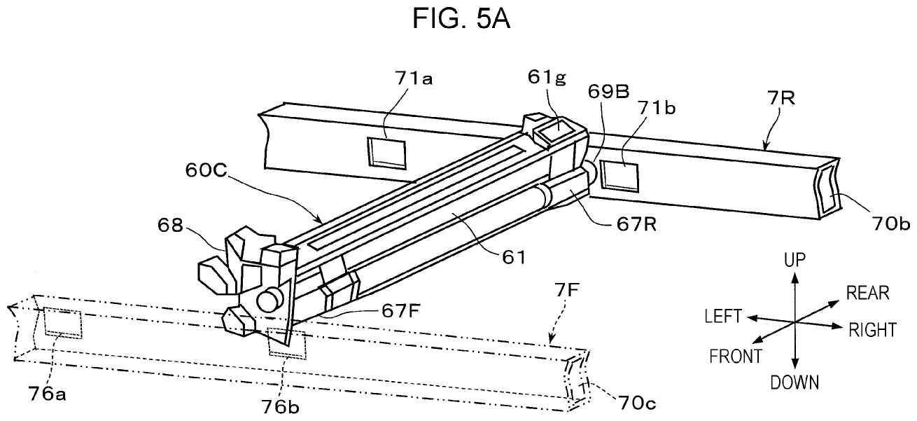

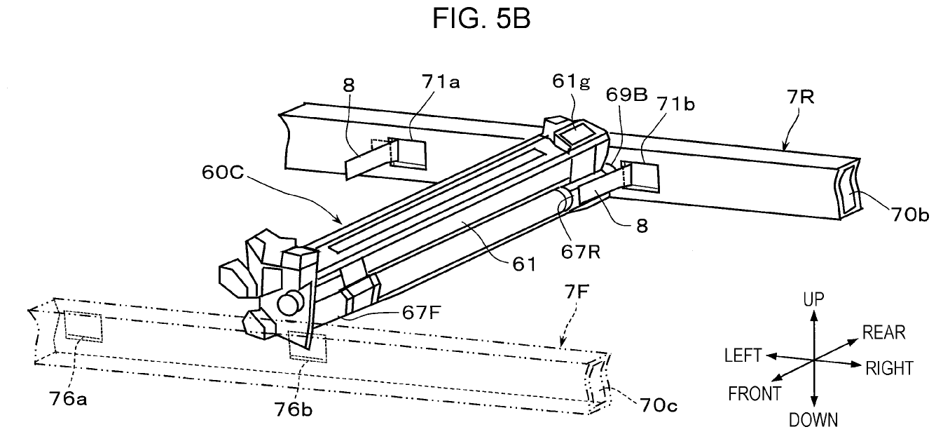

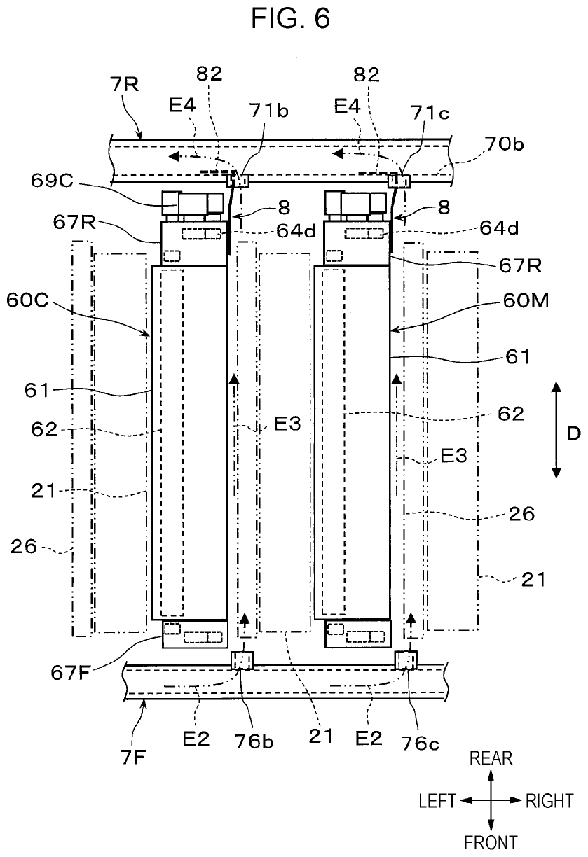

The air outlets 76a, 76b, 76c, 76d, and 76e are openings through which the air E1 flowing into the channel space 70c is discharged toward the developing devices 60(Y, M, C, K, S). As illustrated in FIGS. 4 to 6 and the like, the air outlets 76a, 76b, 76c, 76d, and 76e are provided at parts of the front ventilation duct 7F that face the front ends 60f of the developing devices 60(Y, M, C, K, S).

The air outlets 76a, 76b, 76c, 76d, and 76e are positioned to substantially face the vicinities of the lower parts of the back portions of the housings 61 of the developing devices 60(Y, M, C, K, S) along the longitudinal direction D on the opposite side to the side facing the photoconductor drums 21. For example, the air outlets 76a, 76b, 76c, 76d, and 76e are rectangular openings.

The intake fan 77 sends the outside air E1 into the channel space 70c through the air inlet 75. The intake fan 77 includes a fan driver 77a, a body cover 77b, and a dustproof filter (not illustrated). The intake fan 77 is connected to the air inlet 75 of the front ventilation duct 7F at a part of the body cover 77b.

The rear ventilation duct 7R is an example of a rear ventilator disposed in the housing 10 to pass by the rear ends 60r of the developing devices 60(Y, M, C, K, S) in the longitudinal direction D.

The rear ventilation duct 7R is a tubular structure having a channel space 70b through which air flows. As illustrated in FIG. 4 and the like, the rear ventilation duct 7R laterally extends in a space between the back portion 10r of the housing 10 and the rear support frame 12R.

As illustrated in FIG. 4, the rear ventilation duct 7R has intake ports 71a, 71b, 71c, 71d, and 71e, discharge ports 72a and 72b, and a discharge fan 73.

The rear ventilation duct 7R is made of a synthetic resin, but at least a part of the rear ventilation duct 7R may be made of a metal.

The intake ports 71a, 71b, 71c, 71d, and 71e are openings through which the air discharged through the air outlets 76a, 76b, 76c, 76d, and 76e of the front ventilation duct 7F and passing through the developing devices 60(Y, M, C, K, S) is taken in.

As illustrated in FIGS. 4 to 6 and the like, the intake ports 71a, 71b, 71c, 71d, and 71e are provided at parts of the rear ventilation duct 7R that face the rear ends 60r of the developing devices 60(Y, M, C, K, S). The intake ports 71a, 71b, 71c, 71d, and 71e may be provided to face the air outlets 76a, 76b, 76c, 76d, and 76e of the front ventilation duct 7F across the developing devices 60(Y, M, C, K, S).

The intake ports 71a, 71b, 71c, 71d, and 71e are positioned to substantially face the vicinities of the lower parts of the back portions of the housings 61 of the developing devices 60(Y, M, C, K, S) along the longitudinal direction D on the opposite side to the side facing the photoconductor drums 21. For example, the intake ports 71a, 71b, 71c, 71d, and 71e are rectangular openings.

The discharge ports 72a and 72b are openings through which the air taken in through the intake ports 71a, 71b, 71c, 71d, and 71e is discharged out of the housing 10. In the exemplary embodiment, two discharge ports 72a and 72b are provided in view of intake and discharge efficiencies.

The discharge fan 73 discharges the air taken in through the intake ports 71a, 71b, 71c, 71d, and 71e out of the housing 10 through the discharge ports 72a and 72b. The discharge fan 73 includes a fan driver 73a, a body cover 73b, a first connection pipe 73c, a second connection pipe 73d, and a dustproof filter (not illustrated). The first connection pipe 73c connects a part of the body cover 73b and the discharge port 72a. The second connection pipe 73d connects a part of the body cover 73b and the discharge port 72b.

### (1-6) Operations of Ventilators and Other Components

At an appropriate timing such as a timing of the image forming operation, the image forming apparatus 1 performs an operation of generating a desired airflow in the housing 10 by the front ventilation duct 7F and the rear ventilation duct 7R as described below.

In the image forming apparatus 1, the intake fan 77 is started in the front ventilation duct 7F, and the discharge fan 73 is started in the rear ventilation duct 7R.

In the front ventilation duct 7F illustrated in FIG. 4, the air E1 outside the housing 10 is taken in by the intake fan 77, and flows into the channel space 70c through the air inlet 75 as inflow air E2. In the front ventilation duct 7F, the inflow air E2 is discharged through the air outlets 76a, 76b, 76c, 76d, and 76e while flowing through the channel space 70c.

As a result, the discharged air E3 flows toward the rear of the housing 10 to pass by the lower parts of the back surfaces of the housings 61 of the developing devices 60(Y, M, C, K, S).

Specifically, the discharged air E3 flows rearward in the housing 10 through a clearance in a space surrounded by the lower part of the back surface of the housing 61 of the developing device 60(Y, M, C, K, S), the drum cleaning device 26 of the adjacent image forming unit 20(Y, M, C, S), and the intermediate transfer belt 31. In the developing device 60S, the air E3 discharged through the air outlet 76e flows rearward in the housing 10 through a clearance in a space surrounded by the lower part of the back surface of the housing 61 of the developing device 60S, for example, a coupling frame 14 in a right interior of the housing 10, and the intermediate transfer belt 31.

In the rear ventilation duct 7R illustrated in FIG. 4, the air E3 flowing through the housing 10 is taken into the channel space 70b through the intake ports 71a, 71b, 71c, 71d, and 71e as intake air E4 by an intake action of the discharge fan 73. In the rear ventilation duct 7R, the intake air E4 is split into two streams of intake air E4a and E4b through the discharge ports 72a and 72b while flowing through the channel space 70b, and flows toward the discharge fan 73 through the first connection pipe 73c and the second connection pipe 73d.

The streams of intake air E4a and E4b are collectively discharged out of the housing 10 as discharge air E6 by the discharge fan 73.

As a result, the air E3 flowing through the housing 10 is taken into the rear ventilation duct 7R and then discharged out of the housing 10.

Specifically, the air E3 discharged through the air outlets 76a, 76b, 76c, 76d, and 76e of the front ventilation duct 7F passes by the lower parts of the back surfaces of the housings 61 of the developing devices 60(Y, M, C, K, S), and is then taken into the channel space 70b substantially through the intake ports 71a, 71b, 71c, 71d, and 71e of the rear ventilation duct 7R.

In the image forming apparatus 1, a part of the housing 61 of each developing device 60(Y, M, C, K, S) is exposed to the airflow (flow of the air E3) formed by the air E1 flowing from the outside of the housing 10 through the front ventilation duct 7F. In the image forming apparatus 1, the air passing in contact with the part of the housing 61 of each developing device 60(Y, M, C, K, S) is discharged out of the housing 10 through the rear ventilation duct 7R.

### (1-7) Structure of Thermal Conductor

In the image forming apparatus 1 illustrated in FIGS. 4 to 7B and the like, a thermal conductor 8 in contact with a part of the rear bearing unit 67R at the rear end 60r of each developing device 60(Y, M, C, K, S) is provided to the rear ventilation duct 7R of the ventilators 7.

The thermal conductor 8 transfers heat of the rear bearing unit 67R of each developing device 60(Y, M, C, K, S) to at least the rear ventilation duct 7R. A part of the rear bearing unit 67R may have a relatively high surface temperature when the transport member such as the agitating transport member 64 is driven to rotate.

In the exemplary embodiment, the thermal conductor 8 is in contact with a part of the rear bearing unit 67R that is opposite to the developing roller 62 and close to the intake port 71a, 71b, 71c, 71d, or 71e. More specifically, the thermal conductor 8 continues to be in contact, for a long period along the longitudinal direction D of each developing device 60(Y, M, C, K, S), with an outer surface of a part of the rear bearing unit 67R including a portion where the bearing 64d for the rotation shaft 64a of the agitating transport member 64 is disposed.

In the exemplary embodiment, each individual thermal conductor 8 is in contact with a range from the intake port 71a, 71b, 71c, 71d, or 71e of the rear ventilation duct 7R to a part of the rear bearing unit 67R of each developing device 60(Y, M, C, K, S).

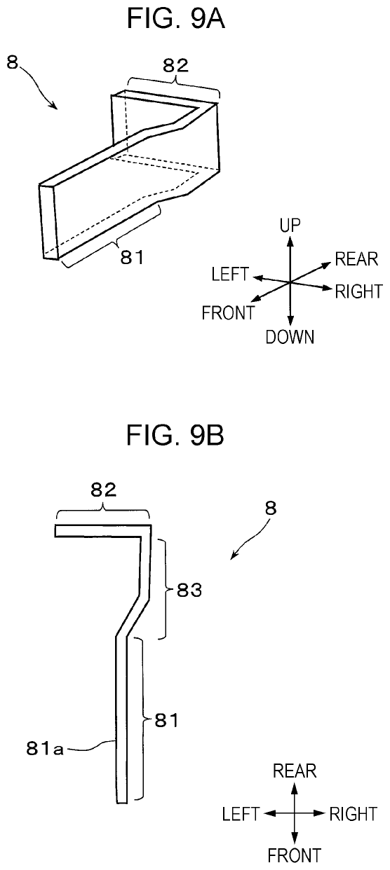

For example, as illustrated in FIGS. 9A and 9B, the thermal conductor 8 is a plate-shaped member including a contact portion 81 in contact with a part of the bearing unit 67R, an attachment portion 82 attached to the rear ventilation duct 7R, and a connection portion 83 connecting the contact portion 81 and the attachment portion 82.

One surface of the contact portion 81 serves as a contact surface 81a in contact with a part of the bearing unit 67R. The contact surface 81a may be a flat surface, but may be a surface having a shape similar to the shape of the outer surface of a part of the bearing unit 67R from the viewpoint of securing a large contact area with the part of the bearing unit 67R.

The attachment portion 82 is shaped to be positioned in the channel space 70b of the rear ventilation duct 7R via one side of the intake port 71a, 71b, 71c, 71d, or 71e and to be in contact with the inner wall surface of the channel space 70b. The attachment portion 82 is fixed to the rear ventilation duct 7R by using a fixing tool or method such as a screw, an adhesive, or welding.

The connection portion 83 is provided to address, for example, a space to be secured as a disposition area for the thermal conductor 8 and adjustment of the positional relationship between the contact portion 81 and the attachment portion 82.

In the exemplary embodiment, the thermal conductor 8 is made of a metal having good thermal conductivity, such as aluminum.

The thermal conductor 8 has elasticity so that the contact portion 81, the connection portion 83, or both of them is/are deformable to be deflected when an external force is received with the thermal conductor 8 attached to the rear ventilation duct 7R. In other words, the thermal conductor 8 may have elasticity like a flat spring.

As illustrated in FIG. 8A, the thermal conductor 8 is in contact with a part of the bearing unit 67R while being elastically deformed to be slightly deflected in an arrow direction when the developing device 60(Y, M, C, K, S) is in the mounted position.

### (1-8) Operations of Thermal Conductor

In the image forming apparatus 1, the front bearing unit 67F and the rear bearing unit 67R have high temperatures due to frictional heat generated in the bearings (bearings 64d and 65d) by the driving of the developing device 60(Y, M, C, K, S).

In the developing device 60(Y, M, C, K, S), the heat causing the high temperatures of the front bearing unit 67F and the rear bearing unit 67R may increase the temperature of the dry developer 18 used in the housing 61.

The thermal conductor 8 transfers the heat of the rear bearing unit 67R of the developing device 60(Y, M, C, K, S) to the rear ventilation duct 7R.

Specifically, the channel space 70b of the rear ventilation duct 7R has a relatively lower temperature than the rear bearing unit 67R by the flow of the air (E4) caused by the airflow generating operation. Therefore, the heat of the rear bearing unit 67R is easily transferred to the rear ventilation duct 7R via the thermal conductor 8.

In the developing device 60(Y, M, C, K, S), the extension portion 61e of the agitating transport path portion 61a is present in the rear bearing unit 67R as illustrated in FIGS. 7A and 7B. Therefore, heat is easily transferred to the developer 18 via the extension portion 61e compared with the front bearing unit 67F.

In the image forming apparatus 1, the heat of the rear bearing unit 67R that may be a heat source causing the temperature increase of the developer 18 is reduced compared with a case where the heat of the rear bearing unit 67R in the longitudinal direction D of the developing device 60(Y, M, C, K, S) is not reduced.

In a case of an image forming apparatus in which the number of image forming units 20 is increased (e.g., the image forming unit 20S in the special color is added) with the overall size of the housing 10 substantially maintained, the image forming units 20 are densely disposed in the limited internal space of the housing 10 and a certain size of space is hardly available. In this case, components such as heat dissipation fins and a ventilator having a channel space through which air flows are more difficult to add along the longitudinal direction D of the developing devices 60(Y, M, C, K, S).

Even in the case of this image forming apparatus, the thermal conductors 8 may be provided because their installation spaces are relatively small.

In the image forming apparatus 1, the thermal conductors 8 are provided to the intake ports 71a, 71b, 71c, 71d, and 71e of the rear ventilation duct 7R.

In the image forming apparatus 1, the thermal conductors 8 are in contact with the air E3 taken in through the intake ports 71a, 71b, 71c, 71d, and 71e of the rear ventilation duct 7R and the heat dissipation is facilitated compared with a case where the thermal conductors 8 are provided to portions other than the intake ports 71a, 71b, 71c, 71d, and 71e of the rear ventilation duct 7R.

In the image forming apparatus 1, the developing devices 60(Y, M, C, K, S) are cooled by air flowing between the rear ventilation duct 7R and the front ventilation duct 7F that may cause air to flow along the longitudinal direction D of the developing devices 60(Y, M, C, K, S) compared with a case where the rear ventilation duct 7R and the front ventilation duct 7F are not provided.

In the image forming apparatus 1, each developing device 60(Y, M, C, K, S) is mountable on or demountable from the housing 10 by the first operation (movement in the fore-and-aft direction) and the second operation (turning). The thermal conductor 8 is an elastic member, and is in contact with a part of the rear bearing unit 67R while being elastically deformed when the developing device 60(Y, M, C, K, S) is in the mounted position.

In the image forming apparatus 1, the thermal conductor 8 is made of a metal.

In the image forming apparatus 1, the thermal conductor 8 is a plate-shaped member.

### Modifications

In the exemplary embodiment, the front ventilation duct 7F may be omitted and the rear ventilation duct 7R may be installed alone as the ventilator 7.

In this case, an air inlet through which air outside the housing 10 flows into the channel space 70b may be provided to the rear ventilation duct 7R in addition to the intake ports 71a, 71b, 71c, 71d, and 71e, the discharge ports 72a and 72b, and the discharge fan 73 described in the exemplary embodiment. For example, the air inlet may be provided to the end of the rear ventilation duct 7R near the intake port 71e (right end in FIG. 4), but may be provided to any other part.

Even in the case where the rear ventilation duct 7R is installed alone, the rear ventilation duct 7R is configured such that the air outside the housing 10 flows into the channel space 70b and is discharged out of the housing 10. Therefore, the temperature is kept relatively lower than the internal temperature of the housing 10, thereby exerting the thermal conduction action of the thermal conductors 8.

In this case, the air inlet need not be added to the rear ventilation duct 7R. In the rear ventilation duct 7R with no additional air inlet, the air flowing from the outside of the housing 10 through an air inlet provided at any other part of the housing 10 may be caused to flow into the intake ports 71a, 71b, 71c, 71d, and 71e.

In the exemplary embodiment, the thermal conductor 8 is not limited to the thermal conductor 8 provided to the rear ventilation duct 7R, and a front thermal conductor 8 in contact with a part of the front bearing unit 67F of each developing device 60(Y, M, C, K, S) may be provided to the front ventilation duct 7F. The front thermal conductor 8 may be in contact with a range from the air outlet 76a, 76b, 76c, 76d, or 76e of the front ventilation duct 7F to a part of the front bearing unit 67F each developing device 60(Y, M, C, K, S).

The thermal conductors 8 may be provided to parts other than the intake ports 71a, 71b, 71c, 71d, and 71e of the rear ventilation duct 7R in place of or in addition to the intake ports 71a, 71b, 71c, 71d, and 71e. In the case where the thermal conductors 8 are provided to the front ventilation duct 7F, the thermal conductors 8 may be provided to parts other than the air outlets 76a, 76b, 76c, 76d, and 76e of the front ventilation duct 7F in place of or in addition to the air outlets 76a, 76b, 76c, 76d, and 76e.

In this structure, the heat of the front bearing units 67F or the rear bearing units 67R of the developing devices 60(Y, M, C, K, S) is transferred to the parts other than the intake ports 71a, 71b, 71c, 71d, and 71e of the rear ventilation duct 7R or the parts other than the air outlets 76a, 76b, 76c, 76d, and 76e of the front ventilation duct 7F via the thermal conductors 8.

In this structure, the parts other than the intake ports 71a, 71b, 71c, 71d, and 71e of the rear ventilation duct 7R and the parts other than the air outlets 76a, 76b, 76c, 76d, and 76e of the front ventilation duct 7F may be made of a metal from the viewpoint of securing more efficient thermal conduction.

In the case where the thermal conductors 8 are provided, the rear ventilation duct 7R and the front ventilation duct 7F may be made of a metal at least at the parts where the thermal conductors 8 are provided.

In this structure, the metal parts of the rear ventilation duct 7R and the front ventilation duct 7F are kept at relatively low temperatures by the flow of air, and the heat is easily transferred satisfactorily by the thermal conductors 8 provided at the metal parts. In this case, the heat of the bearing units 67R and 67F of the developing devices 60(Y, M, C, K, S) is easily transferred to the rear ventilation duct 7R or the front ventilation duct 7F compared with the case where the entire rear ventilation duct 7R and the entire front ventilation duct 7F are made of a material other than the metal.

The rear ventilation duct 7R or both the rear ventilation duct 7R and the front ventilation duct 7F may include a member constituting the housing 10 (e.g., a support frame). The member constituting the housing 10 may have a structure serving as both the rear ventilation duct 7R and the front ventilation duct 7F.

In the exemplary embodiment, the thermal conductor 8 is the plate-shaped member, but may be a thermal conductor having a shape other than the plate shape as long as heat is transferred satisfactorily.

In the exemplary embodiment, the image forming apparatus 1 includes the five image forming units (20Y, 20M, 20C, 20K, 20S) as the image forming units 20 including the developing devices 60. The image forming apparatus according to the exemplary embodiment of the present disclosure may include any other number (single or plural) of image forming units as the image forming units 20.

In a case where the number of image forming units 20 is less than five, the size of the housing 10 may be reduced accordingly. In a case where the number of image forming units 20 is one, the image forming apparatus forms a monochrome image.

In the exemplary embodiment, the developing device 60 includes the collection transport member 66. The developing device 60 according to the exemplary embodiment of the present disclosure may omit the collection transport member 66.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image forming apparatus comprising:
a housing;
a developing device disposed in the housing and comprising a container that contains a developer, a transport member that rotates to transport the developer in the container, and bearing units that bear a shaft of the transport member;
a ventilator disposed in the housing to pass by at least a rear end of the developing device in a longitudinal direction of the developing device and having a channel space through which air outside the housing flows in and is then discharged out of the housing; and
a thermal conductor that is provided to the ventilator and transfers heat of the bearing unit at least at the rear end of the developing device to at least the ventilator by being in contact with a part of the bearing unit.
   (((2)))

The image forming apparatus according to (((1))), wherein the thermal conductor is made of a metal.

(((3)))

The image forming apparatus according to (((1))) or (((2))), wherein the thermal conductor has elasticity.

(((4)))

The image forming apparatus according to any one of (((1))) to (((3))), wherein the thermal conductor is a plate-shaped member.

(((5)))

The image forming apparatus according to any one of (((1))) to (((4))), wherein a part of the thermal conductor that is in contact with the part of the bearing unit has a shape similar to a shape of an outer surface of the part of the bearing unit.

(((6)))

The image forming apparatus according to any one of (((1))) to (((5))), wherein at least a part of the ventilator where the thermal conductor is provided is made of a metal.

(((7)))

The image forming apparatus according to any one of (((1))) to (((6))), wherein the ventilator includes a part of members constituting the housing.

(((8)))

The image forming apparatus according to any one of (((1))) to (((7))),
wherein the ventilator comprises a rear ventilator disposed to pass by the rear end of the developing device in the longitudinal direction,
wherein the rear ventilator has an intake port through which the air outside the housing is taken into the channel space, a discharge port through which the air is discharged out of the housing, and a discharge fan that discharges the air flowing in through the intake port out of the housing through the discharge port, and
wherein the thermal conductor is provided in contact with a range from the intake port to the part of the bearing unit at the rear end of the developing device.
   (((9)))

The image forming apparatus according to any one of (((1))) to (((7))),
wherein the ventilator comprises a rear ventilator disposed to pass by the rear end of the developing device in the longitudinal direction, and a front ventilator disposed to pass by a front end of the developing device in the longitudinal direction,
wherein the front ventilator has an air inlet through which the air outside the housing flows into the channel space, an air outlet through which the air is discharged toward the developing device, and an intake fan that sends the air into the channel space through the air inlet,
wherein the rear ventilator has an intake port through which the air discharged through the air outlet of the front ventilator and passing through the developing device is taken in, a discharge port through which the air taken in through the intake port is discharged out of the housing, and a discharge fan that discharges the air taken in through the intake port out of the housing through the discharge port, and
wherein the thermal conductor is provided in contact with a range from at least the rear ventilator to the part of the bearing unit at the rear end of the developing device.
   (((10)))

The image forming apparatus according to (((9))), wherein the thermal conductor is provided in contact with a range from at least the intake port of the rear ventilator to the part of the bearing unit at the rear end of the developing device.

(((11)))

The image forming apparatus according to any one of (((1))) to (((10))),
wherein the developing device comprises a plurality of developing devices, and
wherein the thermal conductors are provided individually in contact with parts of the bearing units of the plurality of developing devices.

What is claimed is:

1. An image forming apparatus comprising:
a housing;
a developing device disposed in the housing and comprising a container that contains a developer, a transport member that rotates to transport the developer in the container, and bearing units that bear a shaft of the transport member;
a ventilator disposed in the housing to pass by at least a rear end of the developing device in a longitudinal direction of the developing device and having a channel space through which air outside the housing flows in and is then discharged out of the housing; and
a thermal conductor that is provided to the ventilator and transfers heat of the bearing unit at least at the rear end of the developing device to at least the ventilator by being in contact with a part of the bearing unit.

2. The image forming apparatus according to claim 1, wherein the thermal conductor is made of a metal.

3. The image forming apparatus according to claim 2, wherein the thermal conductor has elasticity.

4. The image forming apparatus according to claim 1, wherein the thermal conductor is a plate-shaped member.

5. The image forming apparatus according to claim 1, wherein a part of the thermal conductor that is in contact with the part of the bearing unit has a shape similar to a shape of an outer surface of the part of the bearing unit.

6. The image forming apparatus according to claim 1, wherein at least a part of the ventilator where the thermal conductor is provided is made of a metal.

7. The image forming apparatus according to claim 6, wherein the ventilator includes a part of members constituting the housing.

8. The image forming apparatus according to claim 1,
wherein the ventilator comprises a rear ventilator disposed to pass by the rear end of the developing device in the longitudinal direction,
wherein the rear ventilator has an intake port through which the air outside the housing is taken into the channel space, a discharge port through which the air is discharged out of the housing, and a discharge fan that discharges the air flowing in through the intake port out of the housing through the discharge port, and
wherein the thermal conductor is provided in contact with a range from the intake port to the part of the bearing unit at the rear end of the developing device.

9. The image forming apparatus according to claim 1,
wherein the ventilator comprises a rear ventilator disposed to pass by the rear end of the developing device in the longitudinal direction, and a front ventilator disposed to pass by a front end of the developing device in the longitudinal direction,
wherein the front ventilator has an air inlet through which the air outside the housing flows into the channel space, an air outlet through which the air is discharged toward the developing device, and an intake fan that sends the air into the channel space through the air inlet,
wherein the rear ventilator has an intake port through which the air discharged through the air outlet of the front ventilator and passing through the developing device is taken in, a discharge port through which the air taken in through the intake port is discharged out of the housing, and a discharge fan that discharges the air taken in through the intake port out of the housing through the discharge port, and
wherein the thermal conductor is provided in contact with a range from at least the rear ventilator to the part of the bearing unit at the rear end of the developing device.

10. The image forming apparatus according to claim 9, wherein the thermal conductor is provided in contact with a range from at least the intake port of the rear ventilator to the part of the bearing unit at the rear end of the developing device.

11. The image forming apparatus according to claim 1,
wherein the developing device comprises a plurality of developing devices, and
wherein the thermal conductors are provided individually in contact with parts of the bearing units of the plurality of developing devices.

12. The image forming apparatus according to claim 2,
wherein the developing device comprises a plurality of developing devices, and
wherein the thermal conductors are provided individually in contact with parts of the bearing units of the plurality of developing devices.

13. The image forming apparatus according to claim 3,
wherein the developing device comprises a plurality of developing devices, and
wherein the thermal conductors are provided individually in contact with parts of the bearing units of the plurality of developing devices.

14. The image forming apparatus according to claim 4,
wherein the developing device comprises a plurality of developing devices, and
wherein the thermal conductors are provided individually in contact with parts of the bearing units of the plurality of developing devices.

15. The image forming apparatus according to claim 5,
wherein the developing device comprises a plurality of developing devices, and
wherein the thermal conductors are provided individually in contact with parts of the bearing units of the plurality of developing devices.

16. The image forming apparatus according to claim 6,
wherein the developing device comprises a plurality of developing devices, and
wherein the thermal conductors are provided individually in contact with parts of the bearing units of the plurality of developing devices.

17. The image forming apparatus according to claim 7,
wherein the developing device comprises a plurality of developing devices, and
wherein the thermal conductors are provided individually in contact with parts of the bearing units of the plurality of developing devices.

18. The image forming apparatus according to claim 8,
wherein the developing device comprises a plurality of developing devices, and
wherein the thermal conductors are provided individually in contact with parts of the bearing units of the plurality of developing devices.

19. The image forming apparatus according to claim 9,
wherein the developing device comprises a plurality of developing devices, and
wherein the thermal conductors are provided individually in contact with parts of the bearing units of the plurality of developing devices.

20. The image forming apparatus according to claim 10,
wherein the developing device comprises a plurality of developing devices, and
wherein the thermal conductors are provided individually in contact with parts of the bearing units of the plurality of developing devices.
